(19) United States
(12) Patent Application Publication
(10) Pub. No.: US 2025/0287303 A1
(43) Pub. Date: Sep. 11, 2025

(54) MULTIPLE INPUT/MULTIPLE OUTPUT PATH WIRELESS COMMUNICATION SYSTEM WITH POWER REDUCTION

(71) Applicant: Outdoor Wireless Networks LLC, Claremont, NC (US)

(72) Inventors: Van Erick Hanson, Forest, VA (US); Thomas Kummetz, Bayern (DE)

(73) Assignee: Outdoor Wireless Networks LLC, Claremont, NC (US)

(21) Appl. No.: 18/861,459

(22) PCT Filed: Apr. 7, 2023
(86) PCT No.: PCT/US2023/017871

§ 371 Date: Oct. 29, 2024

Related U.S. Application Data
(60) Provisional application No. 63/336,880, filed on Apr. 29, 2022.

(51) Int. Cl. H04W 52/02; H04B 7/0413

(52) U.S. Cl. CPC H04W 52/0206; H04B 7/0413

(57) ABSTRACT

A communication system having a plurality of multiple input multiple output (MIMO) communication paths with power reduction with is provided. The MIMO communication paths include a plurality of downlink communication paths and a plurality of uplink communication paths. At least some of the downlink communication paths are configured to communicate a same communication signal. Each downlink communication path including a plurality of downlink communication path components. Each uplink communication path including a plurality of uplink communication components. At least one controller is configured to power down at least one of at least one downlink component of the plurality of downlink components and at least one of an uplink component of the plurality of uplink components during at least one power saving mode.

### CROSS-REFERENCE TO RELATED APPLICATIONS

This Application claims priority to U.S. Provisional Application Ser. No. 63/336,880, same title herewith, filed on Apr. 29, 2022, which is incorporated in its entirety herein by reference.

### BACKGROUND

Multiple input/multiple output (MIMO) wireless communication systems may transmit multiple (differing) data streams using the same frequency/channel. That is, multiple radio frequency (RF) signals (MIMO RF signals) are wirelessly transmitted using the same frequency but with different content. MIMO RF signals are used to increase data throughput in the wireless communication systems by allowing more data to be transmitted than can be transmitted on a single transmit signal. Digital coding in the communication signals may be used to identify specific content. Although, a wireless communication system utilizing MIMO RF signals increases data throughput, the system also requires relatively large power consumption because power amplifiers are needed to accommodate additional MIMO communication paths used to generate and transmit the MIMO RF signals.

The high data rates provided by a wireless communication system through all available MIMO communication paths are not always needed. During evening hours or weekends or other times of low traffic, much of the data capacity of a wireless communication system with MIMO communication paths is unused, resulting in power consumption waste. Reducing power, however, may be difficult because of system requirements. Typically, signals are required to be transmitted at certain power levels to provide a desired quality of service for a specific number of channels using a specific number of transmitters for a coverage area. Accordingly, those transmitters need to be turned on to provide the desired quality of service in the coverage area.

Further, in some MIMO systems there are certain reference and synchronization content included in the communication signals that allow user equipment to communication with the system. The communication signals that include the reference and synchronization content may be communicated through only one MIMO communication path and not the other MIMO communication paths in the system. A system that turns off some of the MIMO communication paths during low traffic risk losing the needed reference and synchronization signals in the transmitted MIMO RF signals.

For the reasons stated above and for other reasons stated below which will become apparent to those skilled in the art upon reading and understanding the present specification, there is a need in the art for system to reduce power consumption in a MIMO communication system in an effective manner.

### SUMMARY OF INVENTION

The following summary is made by way of example and not by way of limitation. It is merely provided to aid the reader in understanding some of the aspects of the subject matter described. Embodiments provide a system that turns off at least one component of MIMO communication paths when the associated MIMO communication paths are not needed in a manner that reduces power consumption of the system while still retaining a desired quality of service provided by the communication system.

In one embodiment, a communication system having a plurality of multiple input multiple output (MIMO) communication paths with power reduction with is provided. The MIMO communication paths include a plurality of downlink communication paths and a plurality of uplink communication paths. At least some of the downlink communication paths are configured to communicate a same communication signal. Each downlink communication path including a plurality of downlink communication path components. Each uplink communication path including a plurality of uplink communication components. At least one controller is configured to power down at least one of at least one downlink component of the plurality of downlink components and at least one of an uplink component of the plurality of uplink components during at least one power saving mode.

In yet another embodiment, a distributed antenna system with power reduction is provided. The system includes a plurality of multiple input multiple output (MIMO) communication paths. The MIMO communication paths include a plurality of downlink communication paths and a plurality of uplink communication paths. At least some of the downlink communication paths are configured to communicate a same communication signal. Each downlink communication path includes a plurality of downlink communication path components. Each uplink communication path includes a plurality of uplink communication path components. A master unit is in communication with at least one base station via the plurality of MIMO communication paths. The distributed antennas system further includes a plurality of remote antenna units that provide a communication link for user equipment. Each remote antenna unit is in communication with the master unit via at least one of a downlink communication path and an uplink communication path of the plurality of MIMO communication paths. At least one controller is configured to power down at least one of at least one downlink component of the plurality of downlink components and at least one uplink component of the plurality of uplink components during at least one power saving mode.

In still another embodiment, a method of operating a communication system with a plurality of multiple input and multiple output (MIMO) communication paths. The method includes determining if a power reduction mode should be activated, selecting MIMO communication paths that are configured to communicate a same communication signal to shut down when it is determined that a power reduction mode has been activated, and powering down at least one component of a plurality of components in the selected MIMO communication paths to shut down the selected MIMO communication paths.

### BRIEF DESCRIPTION OF THE DRAWINGS

The present invention can be more easily understood and further advantages and uses thereof will be more readily apparent, when considered in view of the detailed description and the following figures in which:

FIG. 1 is a block diagram of a wireless communication element having MIMO communication paths with power consumption reduction according to one exemplary embodiment;

FIG. 2 is a block diagram of a MIMO path wireless communication system with power reduction according to one exemplary embodiment; and

FIG. 3 is a power reduction flow diagram according to one exemplary embodiment.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the present invention provide a MIMO communication path wireless communication system with power consumption reduction. The communication system may include multiple transceivers transmitting signals on the same channel. Embodiments reduce power consumption by powering down components used in specific MIMO communication paths that are currently not needed for communication. This reduces the number of active MIMO communication paths while still providing a good quality of service. The MIMO communication paths include components in a hardware signal chain used to generate MIMO RF signals. Examples of components being powered down in MIMO communication paths that use a relatively large amount energy and therefore provide a large energy savings include power amplifiers and low noise amplifiers in transceivers. However other components, such a signal processing circuits in a downlink and uplink MIMO communication paths may also be powered down when not needed to conserve energy.

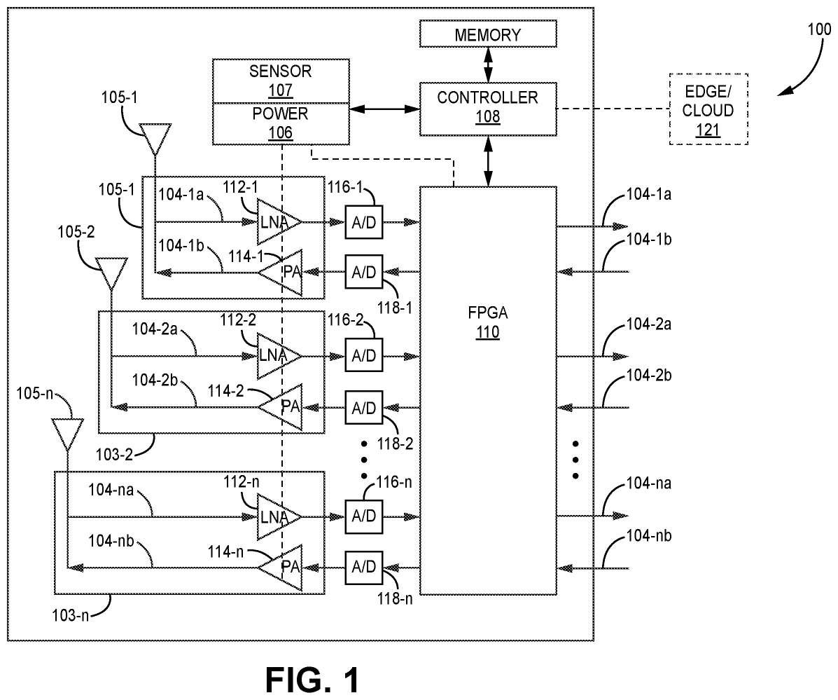

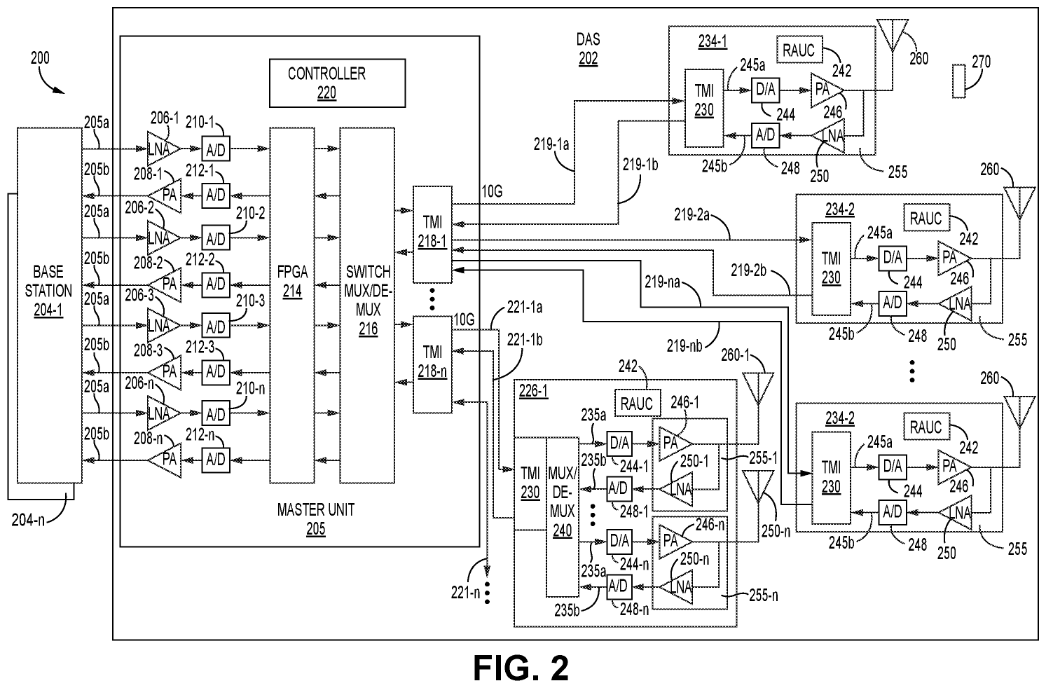

FIG. 1 is an example of a wireless communication element 100 that includes MIMO communication paths with power consumption reduction. The wireless communication element 100 may be part of a wireless communication system that generates MIMO RF signals. Examples of a wireless communication element 100 include base stations, remote antenna units, remote radio heads, repeaters, WiFi access points, a baseband unit (BBU) implementing a long-term evolution (LTE) standard or a management unit associated with the BBU, etc. An example of a wireless communication system 200 that implements wireless communication elements 100 is discussed below in view of FIG. 2.

The wireless communication element 100 in FIG. 1 is illustrated as including a plurality of MIMO communication paths. The MIMO communication paths include paths 104-1a and 104-1b, 104-2a and 104-2b, and 104-2a and 104-2b which can be generically identified as 104. In this example, MIMO communication paths 104 include separate downlink and uplink pair paths such as downlink and uplink pair paths 104-1a and 104-1b. In other embodiments, at least in portions of the MIMO paths 104, both the uplink and downlink communication signals are communicated through the same MIMO communication path. A system that shares a MIMO communication path for both downlink and uplink communication signals may use a timing schedule to coordinate the communication of downlink and uplink communication signals through the communication path.

In the example communication element of FIG. 1, RF downlink signals received at antenna 105-1 are communicated by transceiver 103-1 that includes a low noise amplifier (LNA) 112-1 via path 104-1a, downlink communication signals from antenna 105-2 are communicated by transceiver 103-2 that includes LNA 112-2 via path 104-2a, and downlink communication signals from antenna 105-n are communicated by transceiver 103-n that includes LNA 112-n via path 104-na. RF downlink signals in path 104-1a are then communicated to analog to digital converter (A/D) 116-1, RF downlink communication signals in path 104-2a are communicated to A/D 116-2, and RF downlink communication signals in path 104-na are then communicated to A/D 116-n. The converted digital signals are then passed to a signal processing device such as, but not limited to, a field programmable gate array FPGA (110). The FPGA 110 in this example, includes digital circuitry used to filter and process the digital downlink communication signals in each MIMO communication path 104. The FPGA 110 in this example then outputs the filtered and processed downlink communication signals through MIMO communication paths 104-1a, 104-2a, and 104-na as illustrated in the FIG. 1. Although, a single FPGA 110 is illustrated in the Example of FIG. 1, other embodiments may use separate digital circuitry to filter and process downlink and uplink communication signals.

In the uplink directions, digital uplink communication signals in paths 104-1b, 104-2b and 104nb are communicated to the FPGA 110 where the communication signals are filtered and processed. From the FPGA 110, the digital uplink communication signals are communicated to respective digital to analog converters (D/A) 118-1, 118-2 and 118-n and then to power amplifiers (PA) 114-1, 114-2, and 114-n of the transceivers 103-1, 103-2 and 103-n. The RF uplink communication signals in paths 104-1b, 104-2b and 104-nb are then transmitted through respective antennas 105-1 and 105-2 and 105-n.

The wireless communication element 100 further includes a controller 108. The controller 108 is in communication with a memory 120. The memory 120 stores operational instructions implemented by the controller 108. In general, the controller 108 may include any one or more of a processor, microprocessor, a digital signal processor (DSP), an application specific integrated circuit (ASIC), a field program gate array (FPGA), or equivalent discrete or integrated logic circuitry. In some example embodiments, controller 108 may include multiple components, such as any combination of one or more microprocessors, one or more controllers, one or more DSPs, one or more ASICs, one or more FPGAs, as well as other discrete or integrated logic circuitry. The functions attributed to the controller 108 herein may be embodied as software, firmware, hardware or any combination thereof. The controller 108 may be part of a system controller or a component controller such as a master unit controller, base station controller or remote antenna controller. The memory 120 may include computer-readable operating instructions that, when executed by the controller 108 provides functions of the MIMO path wireless communication system with power consumption reduction. Such functions may include the functions of turning off components when not needed as described below. The computer readable instructions may be encoded within the memory. Memory is an appropriate non-transitory storage medium or media including any volatile, nonvolatile, magnetic, optical, or electrical media, such as, but not limited to, a random access memory (RAM), read-only memory (ROM), non-volatile RAM (NVRAM), electrically-erasable programmable ROM (EEPROM), flash memory, or any other storage medium.

The controller 108, based on the operating instructions stored in the memory 120 controls operation of the wireless communication element 100 in this example. In an energy saving mode, the controller 108 may turn off power to an entire transmit and receive chain for a pair of MIMO communication paths 104 not being used. This may include the digital circuity associated the with the pair of MIMO communication paths in the FPGA 110. For example, if it is determined that MIMO communication paths 104-2a and 104-2b are not needed for communication, the controller 108 may turn the power off to associated LNA 112-2 in the down link MIMO communication path 104-2a and PA 114-2 in the uplink MIMO communication path 104-2b of transmitter 103-2. Digital circuitry associated the MIMO communication paths 104-2a and 104-2b may also be shut down. Multiple MIMO communication paths not being used may be powered off. In one example, where the FPGA 110 has a 4×4 interface, a pair of the MIMO communication paths may be powered down resulting in the FPGA 110 having a 2×2 interface.

In one example, the controller 108, based on instructions, acts as a power savings manager that not only controls the power savings of the MIMO communication paths in the wireless communication element 100 but also other MIMO communication path components in a wireless communication system that is in communication with the wireless communication element 100. Further in one example, machine learning may be deployed in the cloud with edge computing 121 that may determine operating instructions used by the controller 108 to power down MIMO communication paths.

In the example of FIG. 1, a power steering circuit 106, controlled by the controller 108, is used to selectively power down and power up components in select MIMO communication paths 104. Further in an example, a power sensor 107, that is in communication with the controller 108, is used to gather power consumption information in the MIMO paths 104. The controller 108 may use the information from the power sensor 107 to determine such information as current power consumption and how much power is reduced when shutting down MIMO communication paths.

Determining which MIMO communication path or communication paths 104 to power off may be determined by monitoring communication signals (traffic), or lack of traffic, in the monitored MIMO communication paths 104. In another example, a set schedule may be used that predicts when one or more of the MIMO communication paths 104 will not be needed.

FIG. 2 illustrates a wireless communication system 200 that includes a DAS 202 that incorporates the power consumption reduction system discussed above. A master unit 205 of the DAS 202 is in communication with one or more base stations 204-1 through 204-n. The base stations may be generally referenced by 204. The communication link between the at least one base station 204 and the master unit 205 may occur via radio frequency (RF) wireless signals with the master unit 205 and base station 104 using an antenna/transceiver arrangement 105/103 as illustrated in FIG. 1 for each MIMO communication path 205a and 205b to receive and transmit the communication signals.

The master unit 205, in this example, includes a plurality of MIMO communication paths pairs 205a and 205b for downlink communication signals and uplink communication signals. The downlink MIMO communication paths 205a communicate downlink communication signals to respective LNA 206-1 through 206-n of respective transceivers. The downlink communication signals are then communicated to respective A/Ds 210-1 through 210-n where the RF downlink communication signals are converted to digital downlink communication signals. The downlink MIMO communication paths 205a then communicate the digital downlink communication signals to the signal processing device which in this example is a FPGA 214. The FPGA 214 includes digital circuitry for each MIMO communication path. The digital circuitry in the FPGA 214 filters and process both the downlink and uplink communication signals in the respective MIMO communication paths.

The uplink MIMO communication paths 205b from the FPGA 214 communicate respective uplink digital communication signals to D/As 212-1 through 212-n. The converted analog uplink communication signals are then communicated to respective PAs 208-1 through 208-n of respective transceivers where the converted analog uplink communication signals are amplified and communicated to the at least one base station 204. In one example, they are transmitted to the at least one base station 204.

The FPGA 214 in this example is further in communication with switch multiplexer/demultiplexer (MUX) 216. The switch MUX 216 is used to route digital downlink and uplink communication signals in the MIMO paths (generally references by 205) to select remote antenna units 234-1 through 234-n or 226-1. In communication with the switch MUX 216 are transport media interfaces (TMIs) 218-1 through 218-n. The TMIs 218-1 through 218-n in the downlink direction interface the digital downlink communication signals into optical downlink communication signals and communicate the optical downlink communication signals through MIMO communication paths 219-1a, 219-2a, 219-na, 221-1a, which in this case are 10G fiber communication links, to select remote antenna units 234-1 through 234-n and 226-1. In the uplink direction, optical uplink communication signals are communicated to the TMIs 218-1 through 218-n via uplink MIMO communication paths 219-1b, 219-2b, 219-nb and 221-1b in this example. Another example uses the same optical MIMO path to communicate both optical uplink and downlink communication signals using a scheduling scheme to time the communications. The TMIs 218-1 through 218-n interface uplink optical communication signals from the communication links to digital communication signals are passed to MUX 216.

In one example, in the downlink direction, the same optical downlink communication signals are simulcast to an associated group of remote antenna units, such as remote antenna units 234-1 through 234-n. The remote units 234-1 through 234-n transmit MIMO RF signals through antennas 260 which are received by user equipment (UE) 270. Hence the remote units 234-1 through 234-n provide a select communication coverage area with UE 270. Remote antenna unit 226-1 and other associated remote antenna units, repeaters etc. (not shown), in communication via MIMO communication path 221-n, would provide coverage in another coverage area.

The remote antenna units (RAU) 234-1 through 234-n and 226-1 are each shown as including a TMI 230 to interface between optical and digital communication signals. The RAUs 234-1 through 234-n include D/A 244 and PA 246 of a transceiver 255 in a downlink MIMO communication path that are in communication with an antenna 260. A LNA 250 of the transceiver 255 and an A/D 248 are positioned in an uplink communication path between the antenna 260 and the TMI 230 of each RAU 234-1 through 234-n.

A RAU, such as remote antenna unit 226-1, that includes more than one transceiver 255-1 through 255-n/antenna 260-1 through 260-n, may include a switch MUX 240 if servicing more than one service provider. In RAU 226-1, remote antenna unit 226-1 includes a pair of MIMO paths 245a and 245b in the respective downlink and uplink directions for each antenna 260-1 through 260-n. The downlink MIMO path 235a includes D/A 244-1 and PA 246-1 of transceiver 255-1 positioned between the switch MUX 240 and antenna 260-1. The uplink path 235b includes a LNA 250-1 of transceiver 255-1 and A/D 248-1 coupled between the antenna 260-1 and switch MUX 240. Further, for each additional pair of MIMOs, the downlink MIMO path 235a includes D/A 244-n and PA 246-n of transceiver 255-n positioned between the switch MUX 240 and antenna 260-n. The uplink path 235b includes LNA 250-n of transceiver 255-n and A/D 248-n that is coupled between the antenna 260-n and switch MUX 240. As illustrated, other RAUs 226-1 may be in communication with TMI 218-n to form other coverage areas.

Each of the RAUs 234-1 through 234-n and 226-1 includes a remote antenna unit controller (RAUC) 242. The RAUC 242 is in communication with the components of the RAUs 234-1 through 234-n including the PA 246, LNA 250 and transceivers 255. The RAUC 242 may implement instructions to power down components associated with MIMO paths under certain conditions for power saving. In an embodiment, one of the RAUC 242 in the RAU 234-1 through 234-n and 226-1, controller 220 in the master unit 205, a controller in the at least one base station 204 or a remote controller in the cloud acts as a power saving manger to provide instructions to the other controllers regarding which MIMO paths to shut down.

In an example, if it is determined that the MIMO communication paths 245a and 245b associated with RAU 234-2 and MIMO communication paths 235a and 235b associated with RAU 226-1 are not needed and may be shut down to conserve energy, one of the controllers in the master unit, base station or in a remote antenna unit may generate a signal that is passed to the other controllers to power off select MIMO communication paths. Based on the instructions, RAUC 242 of RAU 234-2 will power down components in MIMO communication paths 234-2 and 245b and the RAUC 242 of RAU 226-1 will power down components in MIMO communication paths 235a and 235b. Additionally, associated components in MIMO communication paths in the master unit 205 may be powered down. Moreover, since MIMO communication paths 219-2a and 219b between TMI 218-1 and TMI 230 of RAU 234-2 are not being used in this example, associated circuitry in the TMI 218-1 and TMI 230 of RAU 234-2 may be powered down. Further, a controller in the at least one base station 204 may power down associated MIMO communication paths.

Determining when to power down and power up a MIMO communication path may be based on a schedule. For example, if there are known times when MIMO communication path reduction can be enabled without interfering with communication service, during those times select MIMO path power down may occur.

In another example embodiment, communication signals are monitored to determine if one or more MIMO communication paths can be powered down. In one example, the uplink communication signals are monitored in the uplink MIMO communication paths to determine communication signal traffic levels through MIMO communication paths. Further in an example, a traffic level processing of uplink signals at a base station of a DAS is used to determine when to shut down MIMO communication paths.

In a base station embodiment, the controller, such as controller 108 illustrated in FIG. 1, may be part of a radio access network (RAN) intelligent controller (RIC), distribution unit (DU) or any element within a communication path. In one example, the controller 108 coordinates with a non-real time RIC of the communication system in shutting down and power up MIMO communication paths. Further, as discussed above, in one example, machine learning may be deployed in the cloud with edge computing 121 that may determine operating instructions used by the controllers of elements to power down MIMO communication paths. In an example, at least portions of the controller 108 such as the RIC is located in the edge/cloud 121.

In an example embodiment, the shutting down of a MIMO communication path to conserve energy happens only in situations where it is unlikely the shutdown MIMO communication path will be needed for some select period of time. This prevents a rapid switching on and off of the components in the MIMO communication paths. Further, MIMO communication path powering down of components may be implemented by a slow transition from an active state to a powered down state. This may occur over a period of several seconds. The use of a slow power transition allows the system time to adjust operations to accommodate the losing of MIMO communication paths.

In further an example embodiment, different levels of power savings are implemented depending on an amount of traffic detected. Further, the system may be configured to select between better performance (quality of service) or better power savings based on the power saving level selected.

As mentioned above, in some MIMO systems there are certain reference and synchronization content included in communication signals that may be transmitted in communication signals on only one or only on some of the MIMO communication paths and not in communication signals in the other MIMO communication paths. The reference and synchronization content provides the UE 270 with needed information, such as, symbol timing, physical identity of the cell, frame timing transmission mode and cyclic prefix duration. This information is needed by the UE 270 to communicate with the base station through the DAS 202. A system that turns off some of the MIMO communication paths during low traffic risks losing the needed reference and synchronization content in the communicated communication signals. One example embodiment addresses this issue by monitoring the all the MIMO communication signals and determining which communication signals in which MIMO communication paths include the reference and synchronization content. MIMO communication paths with reference and synchronization content are not powered down in this example.

In another embodiment, an interleave technique is used to ensure the reference and synchronization content is present in the MIMO communication signals traversing through the MIMO communication paths that remain active. An interleave technique mathematically manipulates communication signals so that the reference and synchronization content is present in both MIMO paths. With this technique, a MIMO communication signal without reference and synchronization content is combined with a MIMO communication signal with reference and synchronization content to form two new communication signals that both include the reference and synchronization content.

In one example, a 90-degree hybrid is used to combine two communication signals to make sure the reference and synchronization content are available in both communication signals. The use of a 90-degree hybrid ensures the signals stay orthogonal. In the DAS example, this may occur between the base station and the master unit. The similar result of the 90-degree hybrid may be implemented in the master unit. In an example, the communication system will work at full MIMO communication path capacity at each transmission (radiating) point and then switch to an interleave mode when one or more MIMO communication paths are powered down to ensure reference and synchronization signals are in the downlink communication signals in the active MIMO communication paths. In areas with overlap coverage, the use of an interleave MIMO system may reach close to full MIMO capacity coverage.

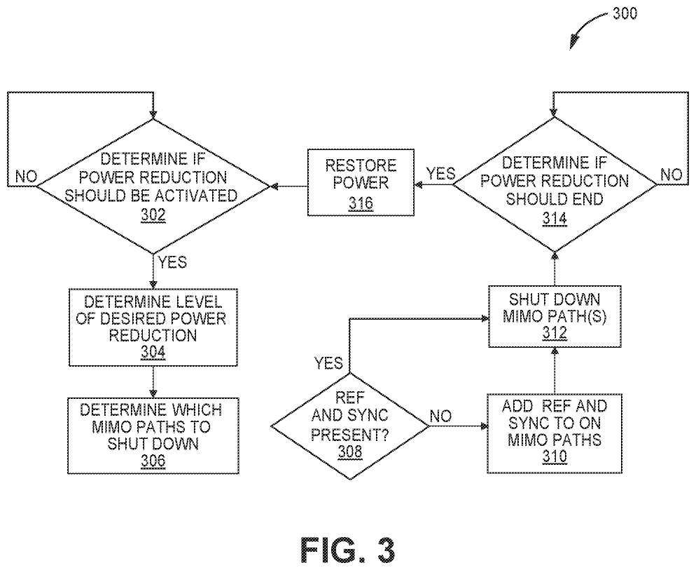

FIG. 3 illustrates a power reduction flow diagram 300 of one example embodiment. The flow diagram is provided as a series of sequential blocks. The sequence of the blocks may occur in a different order or in even in parallel in other examples embodiments. Hence, embodiments are not limited to the sequence set out in FIG. 3.

It is determined at block (302) if a power reduction mode should be activated. In one example embodiment this is done by monitoring traffic levels in the MIMO paths. In another embodiment, this is done on a schedule that anticipates times when services can be reduced.

In one embodiment, a level of desired power reduction is determined at block (304). The levels of desired power reduction may be set to achieve a desired level power reduction verses a quality of service (QOS) based on then current operating conditions. Based on the level of desired power reduction, it is then determined at block (306) which communication paths to shut down.

In an example, it is then determined if the reference and synchronization content is present in the MIMO communication paths that are to remain active at block (308). In one example, as discussed above, only MIMO communication paths that include communication signals with reference and synchronization content are selected to remain active. In another embodiment, techniques are used to insert the reference and synchronization content in communication signals in the MIMO communication paths are selected to remain active at block (310).

Once it is determined that the MIMO communication paths to remain active include communication signals with the reference and synchronization, the selected MIMO communication paths to deactivate are shut down at block (312). As discussed above, the shutting down of components of the MIMO communication paths occurs over a period of time to allow the system to adjusted.

It is then determined at block (314) if the power reduction should end. This may occur by monitoring the traffic in the communication signals in the MIMO communication paths that are still active. In another embodiment, the end of power reduction occurs on a set schedule. When it is determined the power reduction mode should end, the power is restored to the components of the MIMO communication paths that were shut down at block (316). In an embodiment, the power up occurs over a period of time to allow the system to adjust to the components of the MIMO communication paths coming back online. The process then continues at block (302) determining if power reduction should be activated.

### EXAMPLE EMBODIMENTS

Example 1 includes a communication system with power reduction. The communication system includes a plurality of multiple input multiple output (MIMO) communication paths. The MIMO communication paths included a plurality of downlink communication paths and a plurality of uplink communication paths. At least some of the downlink communication paths are configured to communicate a same communication signal. Each downlink communication path including a plurality of downlink communication path components. Each uplink communication path including a plurality of uplink communication components. At least one controller is configured to power down at least one of at least one downlink component of the plurality of downlink components and at least one of an uplink component of the plurality of uplink components during at least one power saving mode.

Example 2 includes the communication system of Example 1, further including at least one power steering circuit in communication with the at least one controller. The at least one controller configured to control the at least one power steering circuit to power down the at least one of the at least one downlink component of the plurality of downlink components and the at least one uplink component of the plurality of uplink components during the at least one power saving mode.

Example 3 includes the communication system of any of the Examples 1-2, wherein the at least one downlink component of the plurality of downlink components and the at least one uplink component of the plurality of uplink components to power down during at least one power saving mode is one of a power amplifier, a low noise amplifier, logic in a field programmable array, a transport media interface, an analog to digital converter, and a digital to analog converter.

Example 4 is a communication system of any of the Examples 1-3, wherein the at least one controller is configured to power up the at least one uplink component of the plurality of uplink components upon completion of the power saving mode.

Example 5 is a communication system of any of the Examples 1-4, wherein the at least one power saving mode includes a plurality of power saving modes. Each power saving mode is based on a desired power savings verses a quality of service.

Example 6 is a communication system of any of the Examples 1-5, wherein the controller is configured to initiate a power saving mode based on one of detected communication signal traffic in at least one uplink communication path and a set schedule.

Example 7 is a communication system of any of the Examples 1-6, further including at least one power consumption sensor to detect a power consumption in at least one of the plurality of downlink communication paths and the plurality of uplink communication paths. The at least one power consumption sensor is in communication with the at least one controller.

Example 8 is a communication system of any of the Examples 1-7, further including a master unit in communication with at least one base station via the plurality of MIMO communication paths and a plurality of remote antenna units providing a communication link for user equipment. Each remote antenna unit is in communication with the master unit via at least one of a downlink communication path and an uplink communication path of the plurality of MIMO communication paths.

Example 9 is a distributed antenna system with power reduction. The system includes a plurality of multiple input multiple output (MIMO) communication paths. The MIMO communication paths include a plurality of downlink communication paths and a plurality of uplink communication paths. At least some of the downlink communication paths are configured to communicate a same communication signal. Each downlink communication path includes a plurality of downlink communication path components. Each uplink communication path includes a plurality of uplink communication path components. A master unit is in communication with at least one base station via the plurality of MIMO communication paths. The distributed antennas system further includes a plurality of remote antenna units that provide a communication link for user equipment. Each remote antenna unit is in communication with the master unit via at least one of a downlink communication path and a uplink communication path of the plurality of MIMO communication paths. At least one controller is configured to power down at least one of at least one downlink component of the plurality of downlink components and at least one uplink component of the plurality of uplink components during at least one power saving mode.

Example 10 includes the system of Example 9, wherein the at least one controller is at least one of a master unit controller and a remote antenna unit controller.

Example 11 includes the system of any of the Examples 9-12, further wherein the downlink communication path components in each downlink communication path in the master unit include a low noise amplifier (LNA) to received radio frequency (RF) communication signals from at least one base station, an analog to digital converter to convert radio frequency (RF) communication signals from the LNA into digital downlink communication signals, at least one signal processing device including digital circuitry to filter and process the digital downlink communication signals, a multiplexer with switch functions configured to combine the digital downlink communication signals and route the combined digital downlink communications to select remote antenna units, and at least one master transport media interface (TMI) configured to the interface the digital downlink communication signals into optical downlink communication signals. The uplink communication path components in each uplink communication path of the master unit include the master TMI configured to interface optical uplink communication signals into digital uplink communication signals, a demultiplexer with switch functions configured to separate out the digital uplink communication signals from the master TMI and route the digital uplink communication signals to a select base station, the at least one signal processing device including digital circuitry to filter and process the digital uplink communication signals, a digital to analog converter to convert the digital uplink communication signals output from the at least one signal processing device to RF uplink communication signals, the power amplifier to amplify the RF uplink communication signals, and a transmitter configured to transmit RF uplink communication signals to the at least one base station.

Example 12 includes the system of any of the Examples 9-11, further wherein the downlink communication path components in each downlink communication path in each remote unit includes a remote TMI configured to interface optical downlink communication signals into digital uplink communication signals, a remote digital to analog converter to convert the digital uplink communication signals to RF downlink communication signals, a remote power amplifier configured to amplify the RF downlink communication signals, and a remote antenna in communication with the remote power amplifier, the remote antenna configured to radiate the RF downlink communication signals. The uplink communication path components in each uplink communication path in each remote unit including, a low noise amplifier in communication with the antenna to receive RF upstream communication signals; a remote analog to digital converter to convert the received RF upstream communication signals to digital upstream communication signals, and the remote TMI configured to interface the digital uplink communication signals to optical downlink communication signals that are communicated to the master unit.

Example 13 includes a method of operating a communication system with a plurality of multiple input and multiple output (MIMO) communication paths. The method includes determining if a power reduction mode should be activated, selecting MIMO communication paths that are configured to communicate a same communication signal to shut down when it is determined that a power reduction mode has been activated, and powering down at least one component of a plurality of communication path components in the selected MIMO communication paths to shut down the selected MIMO communication paths.

Example 14 includes the method of Example 13 wherein determining if a power reduction mode should be activated further comprises one of; monitoring a traffic flow of communication signals in at least uplink communication paths of the communication system; and using a set schedule.

Example 15 includes the method of any of the Examples 13-14, further including selecting a power reduction mode based on a desired power reduction verse quality of service.

Example 16 includes the method of any of the Examples 13-15, wherein selecting MIMO communication paths from a plurality of MIMO communication paths that are configured to communicate the same communication signals to shut down further includes determining which MIMO communication paths include reference and synchronization content and keeping MIMO communication paths with reference and synchronization content active.

Example 17 includes the method of any of the Examples 13-15, further including inserting reference and synchronization content to communication signals in the MIMO communication signals that remain active.

Example 18 includes the method of Example 17, wherein inserting reference and synchronization content to communication signals in the MIMO communication signals further includes combining a first communication signal with the reference and synchronization content with a second communication signal without the reference and synchronization content.

Example 19 includes the method of any of the Examples 13-18, further including monitoring power usage in the components in the plurality of MIMO communication paths.

Examples 20 includes the method of any of the Examples 13-19, further including powering up the at least one component in the selected at least one MIMO path upon an end of the power reduction mode.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A communication system with power reduction, the communication system comprising:
a plurality of multiple input multiple output (MIMO) communication paths, the MIMO communication paths including,
a plurality of downlink communication paths, at least some of the downlink communication paths configured o communicate a same communication signal, each downlink communication path including a plurality of downlink communication path components, and
a plurality of uplink communication paths, each uplink communication path including a plurality of uplink communication components; and
at least one controller configured to power down at least one of at least one downlink component of the plurality of downlink components and at least one of an uplink component of the plurality of uplink components during at least one power saving mode.

2. The communication system of claim 1, further comprising:
at least one power steering circuit in communication with the at least one controller, the at least one controller configured to control the at least one power steering circuit to power down the at least one of the at least one downlink component of the plurality of downlink components and the at least one uplink component of the plurality of uplink components during the at least one power saving mode.

3. The communication system of claim 1, wherein the at least one downlink component of the plurality of downlink components and the at least one uplink component of the plurality of uplink components to power down during at least one power saving mode is one of a power amplifier, a low noise amplifier, logic in a field programmable array, a transport media interface, an analog to digital converter, and a digital to analog converter.

4. The communication system of claim 1, wherein the at least one controller is configured to power up the at least one uplink component of the plurality of uplink components upon completion of the power saving mode.

5. The communication system of claim 1, wherein the at least one power saving mode includes a plurality of power saving modes, each power saving mode based on a desired power savings verses a quality of service.

6. The communication system of claim 1, wherein the controller is configured to initiate a power saving mode based on one of detected communication signal traffic in at least one uplink communication path and a set schedule.

7. The communication system of claim 1, further comprising:
at least one power consumption sensor to detect a power consumption in at least one of the plurality of downlink communication paths and the plurality of uplink communication paths, the at least one power consumption sensor in communication with the at least one controller.

8. The communication system of claim 1, further comprising:
a master unit in communication with at least one base station via the plurality of MIMO communication paths; and
a plurality of remote antenna units providing a communication link for user equipment, each remote antenna unit in communication with the master unit via at least one of a downlink communication path and an uplink communication path of the plurality of MIMO communication paths.

9. A distributed antenna system with power reduction, the system comprising:
a plurality of multiple input multiple output (MIMO) communication paths, the MIMO communication paths including,
a plurality of downlink communication paths, at least some of the downlink communication paths configured to communicate a same communication signal, each downlink communication path including a plurality of downlink communication path components, and
a plurality of uplink communication paths, each uplink communication path including a plurality of uplink communication path components;
a master unit in communication with at least one base station via the plurality of MIMO communication paths;
a plurality of remote antenna units providing a communication link for user equipment, each remote antenna unit in communication with the master unit via at least one of a downlink communication path and a uplink communication path of the plurality of MIMO communication paths; and
at least one controller configured to power down at least one of at least one downlink component of the plurality of downlink components and at least one uplink component of the plurality of uplink components during at least one power saving mode.

10. The system of claim 9, wherein the at least one controller is at least one of a master unit controller and a remote antenna unit controller.

11. The system of claim 9, further wherein:
the downlink communication path components in each downlink communication path in the master unit including,
a low noise amplifier (LNA) to received radio frequency (RF) communication signals from at least one base station,
analog to digital converter to convert radio frequency (RF) communication signals from the LNA into digital downlink communication signals,
at least one signal processing device including digital circuitry to filter and process the digital downlink communication signals,
a multiplexer with switch functions configured to combine the digital downlink communication signals and route the combined digital downlink communications to select remote antenna units, and
at least one master transport media interface (TMI) configured to the interface the digital downlink communication signals into optical downlink communication signals;
the uplink communication path components in each uplink communication path of the master unit including,
the master TMI configured to interface optical uplink communication signals into digital uplink communication signals,
a demultiplexer with switch functions configured to separate out the digital uplink communication signals from the master TMI and route the digital uplink communication signals to a select base station,
the at least one signal processing device including digital circuitry to filter and process the digital uplink communication signals,
a digital to analog converter to convert the digital uplink communication signals output from the at least one signal processing device to RF uplink communication signals,
a power amplifier to amplify the RF uplink communication signals, and
a transmitter configured to transmit RF uplink communication signals to the at least one base station.

12. The system of claim 9, further wherein:
the downlink communication path components in each downlink communication path in each remote unit including,
a remote TMI configured to interface optical downlink communication signals into digital uplink communication signals,
a remote digital to analog converter to convert the digital uplink communication signals to RF downlink communication signals,
a remote power amplifier configured to amplify the RF downlink communication signals, and
a remote antenna in communication with the remote power amplifier, the remote antenna configured to radiate the RF downlink communication signals;
the uplink communication path components in each uplink communication path in each remote unit including,
a low noise amplifier in communication with the antenna to receive RF upstream communication signals;
a remote analog to digital converter to convert the received RF upstream communication signals to digital upstream communication signals, and
the remote TMI configured to interface the digital uplink communication signals to optical downlink communication signals that are communicated to the master unit.

13. A method of operating a communication system with a plurality of multiple input and multiple output (MIMO) communication paths, the method comprising:
determining if a power reduction mode should be activated;
selecting MIMO communication paths that are configured to communicate a same communication signal to shut down when it is determined that a power reduction mode has been activated; and
powering down at least one component of a plurality of components in the selected MIMO communication paths to shut down the selected MIMO communication paths.

14. The method of claim 13, wherein determining if a power reduction mode should be activated further comprises one of:
monitoring a traffic flow of communication signals in at least uplink communication paths of the communication system; and
using a set schedule.

15. The method of claim 13, further comprising:
selecting a power reduction mode based on a desired power reduction verse quality of service.

16. The method of claim 13, wherein selecting MIMO communication paths from a plurality of MIMO communication paths that are configured to communicate the same communication signals to shut down further comprises:
determining which MIMO communication paths include reference and synchronization content; and
keeping MIMO communication paths with reference and synchronization content active.

17. The method of claim 13, further comprising:
inserting reference and synchronization content to communication signals in the MIMO communication signals that remain active.

18. The method of claim 17, wherein inserting reference and synchronization content to communication signals in the MIMO communication signals further comprises:
combining a first communication signal with the reference and synchronization content with a second communication signal without the reference and synchronization content.

19. The method of claim 13, further comprising:
monitoring power usage in the components in the plurality of MIMO communication paths.

20. The method of claim 13, further comprising:
powering up the at least one component in the selected at least one MIMO path upon an end of the power reduction mode.
